(19) United States
(12) Patent Application Publication
(10) Pub. No.: US 2007/0038553 A1
(43) Pub. Date: Feb. 15, 2007

(54) FULL PRICE PROTECTION METHOD AS A MARKETING TOOL

(76) Inventors: Jeffrey A. Miller, Naperville, IL (US); Hemant Lall, Dallas, TX (US); Robert D. Hamman, Dallas, TX (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/464,720

(22) Filed: Aug. 15, 2006

Related U.S. Application Data
(60) Provisional application No. 60/708,254, filed on Aug. 15, 2005.

(51) Int. Cl. G06Q 40/00

(52) U.S. Cl. 705/37; 705/35

(57) ABSTRACT

Protection is provided against increases in the price of fuel. As an example, the protection may be provided for an agreed in advance quantity of fuel and/or for an agreed in advance duration.

### RELATED APPLICATION DATA

This application claims priority of U.S. Provisional Application No. 60/708,254 filed on Aug. 15, 2005, which is incorporated herein by reference in its entirety.

### TECHNICAL FIELD

The present invention relates generally, as indicated, to fuel price protection method as a marketing tool, and, more particularly, to making protection against fuel price increases a feature or option of vehicle sales or leases. The invention also relates to extending hedging strategies to consumers of fuel and providing fuel price buy downs and free fuel features as incentives to purchasers of automobiles.

### BACKGROUND

Increasing competition to sell automobiles has led to a number of incentives offered to prospective purchasers. One incentive has been a no interest loan or low interest loan. While a purchaser may be attracted by this incentive, it does not address the after purchase indefiniteness of fuel price increases that may make driving the automobile too costly and may cause the purchaser to drive less, whereby the time longevity of the vehicle would increase, thus reducing future purchases.

Another recent sales incentive has been to offer to consumers discounts comparable to those given to employees of an automobile manufacturing company. These incentives also are attractive, but they do not address the issue of future fuel price increases and may lead to some discontent among employees of the automobile manufacturing company—although more vehicles may be sold and job security may increase, relative advantages provided to the automobile company employees in effect diminish.

Still another incentive has been to provide an automobile purchaser free gasoline for a period of time, e.g., for one or more years following the purchase. Actually, such incentive usually is in the form of providing the purchaser a fixed amount of money, e.g., $1,200 per year toward the purchase of gasoline. Thus, this incentive does not address the possibility of rising fuel prices faced by the purchaser.

### SUMMARY

In accordance with an aspect of the present invention, protection is provided against increases in the price of fuel. As an example, the protection may be provided for an agreed in advance quantity of fuel and/or for an agreed in advance duration.

Several exemplary uses of the price protection include providing the protection to consumers via the seller of automobiles, to the seller of the automobiles, to the manufacturer of the automobiles, via leasing agents of automobiles, etc., and, if desired, providing the right to transfer the incentive to others. For example, an automobile manufacturer may transfer the incentive to automobile dealers who in turn may transfer the incentive to their customers (e.g., purchasers of the automobiles).

Another aspect relates to a method of encouraging vehicle sales, including providing a vehicle purchaser an assurance that fuel for a purchased vehicle can be purchased in effect at a prescribed pricing.

Another aspect relates to a method of providing quantitative value to a consumer in a consumer transaction, including providing fuel price protection for a fuel quantity over a time period, including providing payment to the consumer or the consumer's designee based on the difference between a first value of an established fuel price and a second value related to the actual price of the fuel quantity if the second value exceeds the first value.

Another aspect relates to a method of providing vehicle fuel-related price protection, including acquiring financial instruments to acquire a fuel product at future times, based at least in part on the cost to acquire such financial instruments, on the anticipated value of such financial instruments during a first prescribed time frame, and on the anticipated average price of vehicle fuel during a second time frame, determining a commercially valuable price at which to sell fuel price protection for a quantity of fuel to provide payment to a consumer, customer or their designee based on the difference between a first value of an established fuel price and a second value related to the actual price of the fuel quantity if the second value exceeds the first value.

Another aspect relates to a method of providing price protection for fuel, including guaranteeing that the effective cost per unit of fuel over a given time period will not exceed a predetermined price.

These and other objects, features, advantages and functions of the invention will become more apparent as the following description proceeds.

It will be appreciated that although the invention is described with respect to one or more embodiments, the scope of the invention is limited only by the claims and equivalents thereof.

It also will be appreciated that although the invention may be described with respect to several embodiments, features of a given embodiment also may be used with one or more other embodiments.

To the accomplishment of the foregoing and related ends, the invention, then, comprises the features hereinafter described in the specification and particularly pointed out in the claims, the following description and the annexed drawings setting forth in detail certain illustrative embodiments of the invention, these being indicative, however, of but several of the various ways in which the principles of the invention may be suitably employed.

### BRIEF DESCRIPTION OF THE DRAWINGS

In the annexed drawings,

FIG. 1 is a block diagram schematically illustrating a price protection incentive business method according to the present invention;

FIG. 2 is a block diagram schematically illustrating advance preparation to provide price protection in accordance with an exemplary embodiment of the invention;

FIG. 3 is a block diagram schematically illustrating a method of providing fuel price protection in accordance with an exemplary embodiment of the invention;

FIG. 4 is a schematic illustration of a system for carrying out the invention;

FIG. 5 is a block diagram schematically illustrating implementation of different price protection methodologies in accordance with exemplary embodiment of the invention;

FIG. 6 is a block diagram schematically illustrating a method of implementing a buy down of fuel prices in accordance with an exemplary embodiment of the invention;

FIG. 7 is a block diagram schematically illustrating a method of implementing fixed price protection in accordance with exemplary an embodiment of the invention;

FIG. 8 is a block diagram schematically illustrating a method of implementing price increase protection in accordance with exemplary an embodiment of the invention; and

FIG. 9 is a block diagram schematically illustrating a method of implementing a qualification for price protection in accordance with an exemplary embodiment of the invention.

### DESCRIPTION

In the description and claims hereof terms, such as, fuel, gasoline, gas, diesel fuel, oil, etc., may be used; in generally these terms are used equivalently and interchangeably unless otherwise specifically indicated or indicated by context. Also, terms, such as, purchase, sale, lease, rent, etc., may be used; in general these terms are used equivalently and interchangeably unless otherwise specifically indicated or indicated by context. Further, terms, such as, vehicle, automobile, truck, etc., may be used; in general these terms are used equivalently and interchangeably unless otherwise specifically indicated or indicated by context. Also, although the invention is described with respect to fuel used in an automobile, such as, for example, a conventional personal automobile that may be used for work use, pleasure use or other use, it will be appreciated that the invention may be used in connection with uses of the automobile for other purposes. Additionally, although the invention is described with respect to fuel used by an automobile, it will be appreciated that fuel is a consumable and the invention may be used in connection with other consumables.

The invention is described mainly in the context of a sale of an automobile by a dealer/manufacturer to a purchaser. It will be appreciated, however, that the invention has other applications, and reference to a purchaser and dealer/manufacturer is merely exemplary. For example, the invention is applicable to anyone using embedded fuel price protection to sell or lease a vehicle, including auto dealers, auto manufactures, leasing consultants, leasing agents (including consultants and/or agents working on behalf of a business that is purchasing or leasing a fleet of vehicles), or the like. As used herein, the term guarantee refers to an agreement in which a person, entity, or the like, assumes the responsibility of assuring and/or fulfilling an obligation.

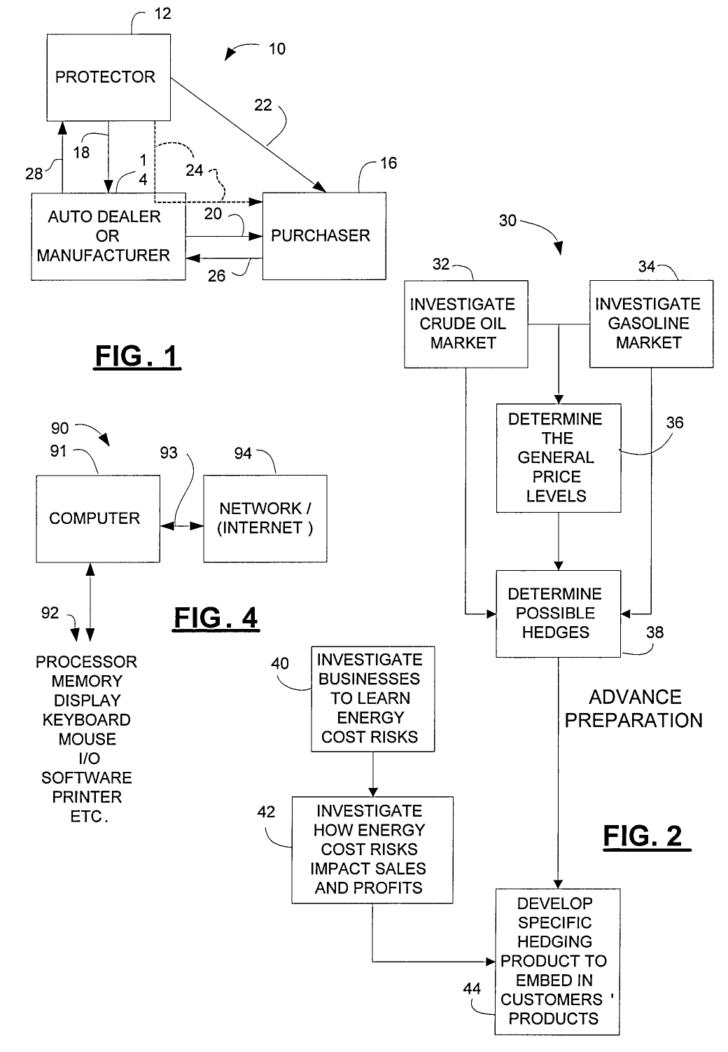

Turning, now, to the drawings, wherein like reference numerals designate like parts in the several figures, and initially to FIG. 1, a block diagram illustrates an example of the method or system 10 of in accordance with the invention. In FIG. 1 a protector 12 provides fuel price protection to an automobile dealer or manufacturer 14 and/or to a purchaser 16 of an automobile. The protector 12 may be a person, a company, e.g., a finance company, bank, investment company, etc.

The price protection may be provided in one or more ways. For example, the protector 12 may provide the protection to the dealer or manufacturer 14 (e.g., as is represented by the arrow 18), who in turn may pass along all or part of the price protection to the purchaser 16 (arrow 20). The protector 14 may provide the price protection directly to the purchaser 16 (arrow 22). The protector 14 may provide the full price protection to the purchaser 16 via a direct pass through of the dealer 14 (arrow 24).

Payment for the price protection may be provided to the protector 12 directly and in a sense solely by the dealer or manufacturer 14, thus reducing the profit on the sale of an automobile, on the one hand, but increasing the number of automobiles sold (sales volume) to purchasers because the price protection incentive is likely to encourage more purchasers to purchase automobiles. Payment for the price protection may be provided (arrow 26) by the purchaser 16 to the dealer, for example, who in turn would pay (arrow 28) the protector 12 for the price protection or would retain the payment itself (or in combination with the manufacturer) and, thus, would provide the price protection without the need for a separate entity as the protector. Also, it is possible that the dealer or manufacturer 14 may provide fuel price protection to the purchaser 16 without charge to the purchaser; and in such case the dealer or manufacturer may absorb the cost for such fuel price protection whether that cost is paid to a protector 12 or the fuel price protection is provided by the dealer or manufacturer 14 itself.

As an example price protection is provided by the protector 12. In the interest of brevity this example is carried forward hereinbelow, whereby it is the protector 12 that provides the price protection rather than the dealer or manufacturer 14 providing the price protection, although it will be appreciated that the dealer or manufacturer or some other entity may provide the price protection. The protector 12 provides assurances to the purchaser 16, for example, that over a given period of time (sometimes referred to as time period or limited period of time, etc.) the purchaser can buy gasoline for the automobile at a fuel price that does not exceed a given price (sometimes referred to as predetermined price or prescribed pricing or the like). In this example the fuel price is the average price of gasoline, e.g., gasoline of a quality or octane rating recommended for the purchased automobile (sometimes referred to as average price); and the period of time is one month. The fuel price may be determined using an independent indicator of the price, such as the New York Mercantile Exchange, for example. The fuel price also may be determined with respect to geographical considerations, e.g., within the city, county, state or some other region where the purchaser resides, where the automobile dealer is located, etc. The fuel price may be the price of fuel including taxes and/or other add-ons in addition to the price of the fuel, for example, or excluding taxes and/or other add-ons. The prescribed pricing may be set according to geographical and/or other factors. The quantity of gasoline (fuel quantity) for which the price is protected over the given time period may be predetermined, e.g., fifty gallons. The duration that price protection may be provided may be a number of months, e.g., for from about one year to about three years (sometimes referred to as protection duration or simply as duration). It will be appreciated that the values expressed are exemplary only and may be more or less than those expressed. For example, the time period may be more or less than one month; the predetermined price may be something other than average price per month; the fuel quantity may be more or less than fifty gallons; and the protection duration may be more or less than twelve to thirty-six months (one to three years).

Applying the above example, an automobile dealer and/or automobile manufacturer 14 offer(s) to purchasers 16 fuel price protection as an incentive to purchase an automobile. The purchaser 16 purchases an automobile. The price protection fee is paid to the protector 12, for example (arrow 24 and possibly arrow 25). In accordance with the price protection program, at the end of each calendar month the protector computes or obtains the average price per gallon (or other quantity) of gasoline of the octane rating and type, e.g., unleaded or leaded, that is recommended for the purchased automobile. The difference between the average price per gallon and the protected price is determined; and if the average price exceeds the protected price, then the amount of that difference times the fuel quantity is forwarded by the protector 12 directly to the purchaser 16 (arrow 23). If the average price does for the given time period does not exceed the protected price, then no payment would be provided the purchaser 16 for that time period.

Another approach to fuel price protection of the invention provides a predetermined quantity of fuel to a purchaser of an automobile, e.g., fifty gallons per month. Using the principles of the invention the approximate cost for the gasoline over the duration of the price protection provided to the purchaser, the cost to provide such quantity of gasoline can be determined and, for example, charged by the protector 12 to the dealer 14 or to the customer 16 to be paid to the protector. This method is different from prior methods in which the purchaser is given a fixed sum of money, which does not take into consideration fluctuations in gasoline price.

It will be appreciated that in the preceding example various modifications may be included and/or substituted. For example, the payment to the purchaser may be provided by the dealer or manufacturer (arrow 22). Part of the price protection may be retained by the dealer or manufacturer. The price protection payment to the purchaser 16 may be provided in full from the protector 12 via the dealer or manufacturer (arrow 24). Other modifications also are possible within the spirit and scope of the invention.

Turning to FIG. 2, a schematic block diagram 30 illustrating advance preparation to provide fuel price protection is shown. At blocks 32 and 34 crude oil and gasoline (e.g., refined crude oil) are investigated. Examples of such investigation include current supplies and demand and estimates of further supplies and demand. The gasoline market investigation 34 may include separate investigations for gasoline of different octane ratings or other characteristics that are recommended for respective automobiles. Current and estimated pricing for the crude oil and gasoline markets also may be included as part of the investigation, and from all the information obtained from the investigations and possibly from other sources, the general price levels for crude oil and for gasoline are determined at block 36.

The information obtained from the investigations carried out at blocks 32 and 34 and the determinations carried out at block 36 may be used to determine possible hedges at block 38. Determination of possible hedges include determining steps to carry out to provide price protection even though actual prices for crude oil and/or for gasoline may vary over time, on the one hand, and the fee for providing such price protection, e.g., the fee charged by the protector 12 to the dealer or manufacturer 14 and/or to the purchaser 16 (FIG. 1), on the other hand. Examples of hedges may include one or more of acquiring by purchase or otherwise options (e.g., calls, puts, etc.), futures, combinations of the foregoing and/or other instruments or mechanisms that may be purchased and sold to provide funding to pay the purchaser (arrow 23, FIG. 1) to fulfill the obligation promised by the protector 12, for example.

At block 40 the protector may investigate businesses to learn energy cost risks, for example, if these are not already known. Also, at block 42 the protector may investigate how energy cost risks impact sales and profits in the automobile sales industry or in some other industry in which the invention is used. Further, if desired, the investigation of how energy cost risks impact sales and profits at block 42 also may be used to determine how such risks affect sales and profits of the fuel product itself and possibly also how they affect the efforts undertaken to obtain supplies of the fuel product, e.g., crude oil and refined gasoline.

In FIG. 2 at block 44 a specific hedging product is developed using the determinations and investigation results from blocks 38, 40 and 42. The hedging product may be one or more of options, futures, combinations thereof and/or other legal and/or financial instruments that provide value, e.g., profits and/or funds supply, available for the protector 12 to provide payments to purchasers 16 as required by the promised fuel price protection. The hedging product may be embedded in customers' products, e.g., in the price of an automobile sold by a dealer 14 to a purchaser 16. Embedding may provide for the cost of the hedge to be included in the automobile price or, if desired, the cost of the hedge may be a separate purchase, e.g., as in the separate purchases of an extended warranty, etc.

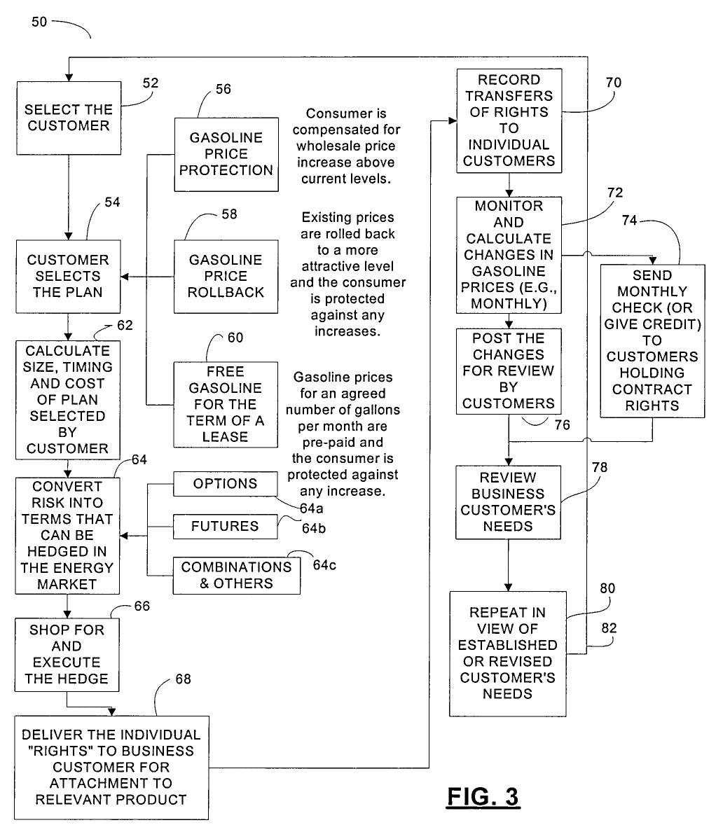

Turning to FIG. 3, a block diagram 50 of a method of providing fuel price protection in accordance with an exemplary embodiment of the invention is illustrated. At block 52 a customer is selected by the protector 12 (FIG. 1), for example. The customer (also referred to herein as purchaser) may be an individual who desires to purchase an automobile, an automotive manufacturer, an automotive dealer, a fleet manager that purchases a fleet of automobiles, etc. The invention may apply to any of those customers and may apply to other customers, too, depending on the product being purchased, the consumable that is to be covered by the price protection, etc. In the description below the example of the invention is presented as a protector 12 providing protection to a purchaser of an automobile, as was mentioned above. It will be appreciated that the features of the invention may be used with other customers and for other consumables than fuel.

At block 54 the purchaser (also referred to herein as customer) may select the desired fuel price protection plan, if more than one plan is offered, e.g., offered by the protector 12 and/or via the dealer or manufacturer 14. In the illustrative block diagram 50 three plans are shown. It may be the case that there is no possibility of selecting the plan, but rather only one of the illustrated plans is available to the purchaser. Block 56 represents gasoline price protection, whereby the consumer is compensated for wholesale price increases above current levels existing at the time of purchasing the automobile or some other specified time. Block 58 represents gasoline price rollback, whereby existing gasoline prices are rolled back to a more attractive level and the consumer is protected against increases, e.g., as in block 56. Thus, block 58 may be a particularly interesting incentive under which the price of the automobile may be increased, when considering the cost for the fuel price protection, on the one hand, while on the other hand the price of operating the automobile is reduced relative to not only current prices but also relative to anticipated price increases for fuel. In a sense the purchaser shares the risk of fuel price changes by paying more for the automobile or for the fuel price protection than in block 56, because the price of fuel may decrease rather than increase. Block 60 represents free gasoline for the term of a lease (or for a prescribed period of time following the purchase of an automobile); in this case the gasoline price for an agreed number of gallons of gasoline per month may be pre-paid by the purchaser and the purchaser is protected against price increases. Although the fuel price protection described with respect to blocks 58 and 60 are somewhat different from the fuel price protection described with respect to block 56 and with respect to FIG. 1, all are examples of fuel price protection provided by the invention.

At block 62 the size, timing and cost of the plan selected by the customer is calculated. For example, if the customer is a purchaser of a single automobile and the duration of the plan is to be three years, the calculation may take one form based on the information and decisions and determinations obtained according to the method illustrated and described with respect to FIG. 2. If the customer is a purchaser of a fleet of automobiles for use for several years by employees of the customer, or if the customer were an automobile leasing company or leasing agent, the calculation may be different for each situation. A preliminary price to charge the customer may be determined by this calculation.

At block 64 risk of price increases is converted into terms that can be hedged in the energy market. Examples of instruments, e.g., options, 64a, futures, 64b, combinations and/or other instruments 64c are described above. As an example, an option to purchase a quantity of gasoline or crude oil at a given price may be purchased; if the price of either gasoline or crude oil increases, then the option increases in value and may provide some or all of the funds or other value needed to pay the purchaser according to the plan of block 56. Possibly a call option may be purchased to purchase a quantity of gasoline or crude oil at a given price even if the price of gasoline or crude oil increases; this call option is one example of a hedge that may allow the protector 12 to acquire funds or other value with which to pay the purchaser 16 in the event that the described option does not provide adequate funds or value. This is but one example of a possible hedge; others are possible, too.

At block 66 the protector 12, for example, shops for and executes the hedge. For example, the price for the swap and the price for the put may be different from different sources and may have different terms from different sources. Other factors may affect those prices, e.g., geographical location, transportation and transport (such as pipelines and their fees) facilities, weather conditions, political climate, etc. Shopping for the options and other instruments, etc., that would provide the hedge to protect the protector 12 so that the protector economically can provide the payments to the purchaser (arrow 22, FIG. 1, for example), allows the protector to provide the fuel price protection that is to be offered to the purchaser of the automobile. The hedge is executed at block 66, whereby the options, and/or other instruments, etc., are acquired by the protector 12. As market conditions, weather, politics, etc., change during the term of the fuel price protection provided, adjustments may be made in the hedge, e.g., purchasing additional options, selling options, buying or selling puts, etc. to provide assurances to the protector 12 to be able to meet the requirements of the fuel price protection plan provided to the purchaser (customer).

At block 68 of FIG. 3 the protector 12 (FIG. 1) delivers the individual “rights” of fuel price protection according to the fuel price protection plan (e.g., block 56). The rights may be delivered to a business customer, such as an automobile dealer or manufacturer 14 (FIG. 1) with the allowance for that business customer to provide the rights to its customer, e.g., the ultimate purchaser of the automobile or automobiles, e.g., in the case of a fleet purchase. The right to the fuel price protection may be attached to, e.g., be sold as part of, the automobile or, as was mentioned above, may be separately sold as are extended warranties.

Block 70 illustrates recording of the transfer of rights to individual customers. For example, if the right was provided to an automobile manufacturer, that entity could transfer the right to an automobile dealer; and the automobile dealer may transfer the right to its customer who purchases the automobile. A record of the customers may be retained by the dealer or by the protector 12; it is advantageous for the protector to maintain that record so that there is no record keeping imposition on the dealer, and in this case payments to the purchaser would come promptly and directly from the protector. If desired the payments to the purchaser may be provided by the protector based on information provided by the dealer; or if desired the payments may be provided by the protector to the dealer, who may provide appropriate payments (either the full amount or a reduced amount in which case the dealer retains a portion of the payment) to the purchaser.

At block 74 a payment is made to the purchaser 16 (FIG. 1) based on the monitoring and calculating carried out at block 72, for example. The payment may be a check or cash payment or it may be in the form of credit given to a credit card of the purchaser. The payment may be made to an individual in the case that the individual has purchased the automobile. In the event that the purchaser was a purchaser, e.g., a company, of a fleet of automobiles (more than one, for example), regardless of the intended uses for those automobiles, it is possible that the payment would be made to that purchaser for a number of or for all of the automobiles that were purchased.

At block 76 the calculated changes and/or other information may be posted for review by customers (purchasers). This information may be provided at a website and may be viewable by those who are receiving the fuel price protection. It is possible that security may be provided so that a purchaser may only review his or her own records. The records may include information of the average price for gasoline of the prescribed octane rating for that purchaser's automobile in that person's local geographical area for the immediately closing month, etc. Such average price information is publicly available, and the invention may use the publicly available information in providing the calculation at block 72 and for posting at block 76.

At block 78 the business customer's needs may be reviewed, if desired. Such review may include confirming that the plans of fuel price protection used by or offered to that business customer are assisting that customer to sell automobiles. If necessary, at block 80 the several steps described above may be repeated in an effort to accommodate revised or refined needs of the customer, whether a business customer, individual purchaser, etc.

A loop line 82 is illustrated in FIG. 3 to depict the possibility of repeating the above described functions either as part of providing payments to the purchasers, business customers, and the like, and/or to refine the plan to meet the current needs of the business customer, individual purchasers, etc.

Briefly referring to FIG. 4, a system 90 for carrying out the invention is illustrated. The system includes a computer 91 with associated parts 92, e.g., software, memory, processor, display, keyboard, mouse, other input/output devices, printer, etc. The system also includes a connection 93 to a network 94, e.g., to the internet by which information is received as to purchasers who are entitled to fuel price protection rights of the invention and via which credits may be given to a purchaser's credit card account, authorization to dispatch payments to a purchaser may be given, average monthly gasoline price information and other information can be obtained, etc. Also, the computer may be used to print checks, if desired, for mailing to the purchasers as appropriate according to the provided fuel price protection. Still further, the computer and/or other parts of the system may be used to obtain information for making judgments as to which instruments to purchase and/or to sell to execute a hedge, and to carry out those purchases and sales.

As discussed herein, a purchaser 16, as an incentive to purchase a motor vehicle, may be offered by a dealer/manufacturer 14 the right to buy fuel at a pre-negotiated rate. That rate may be, for example, a fixed price for a predetermined time period (e.g., the price paid by the purchaser for fuel will remain constant despite changes in the fuel market) or a variable price that will not exceed a pre-negotiated price.

For example, the incentive plan may specify that the purchaser 16 is entitled to buy a predetermined amount of fuel each month for a fixed time period at a fixed price, regardless of whether fuel prices increase or decrease. In essence, such an agreement may be viewed as a prepayment of fuel at the current market price. Alternatively, the incentive plan may specify that the purchaser 16 is entitled to buy a predetermined amount of fuel each month for a fixed number of months, wherein the fuel price will not exceed the market price at the time of the agreement (referred to as the capped price). If the price drops below the capped price, the purchaser 16 enjoys the benefit of buying cheaper fuel (i.e., he is not locked in to the capped price). However, if the fuel price increases above the capped price, the purchaser 16 will be reimbursed (e.g., each month) for the difference between the market fuel price and the capped price. A variation of this plan may be that the agreement calls for the price of fuel to be “bought down”. That is, the purchaser 16 is entitled to purchase a predetermined amount of fuel at a pre-negotiated rate that is less than the average fuel price.

The various methodologies described herein may be implemented using financial instruments, such as a swap, call option, put option, or the like. As is well known, a swap is a derivative, where two counter parties exchange one stream of cash flows against another stream. The cash flows are calculated over a notional principal amount. A call option provides the right but not the obligation to buy at a specified price. A put option provides the right but not the obligation to sell at a specified price. The call option and/or put option each can have an expiration date in which they are lost if not executed prior to expiration. Preferably, the call option is based on the average price each day over the period of the agreement. The particular options that may be implemented for each of the price protection methodologies are described in more detail below.

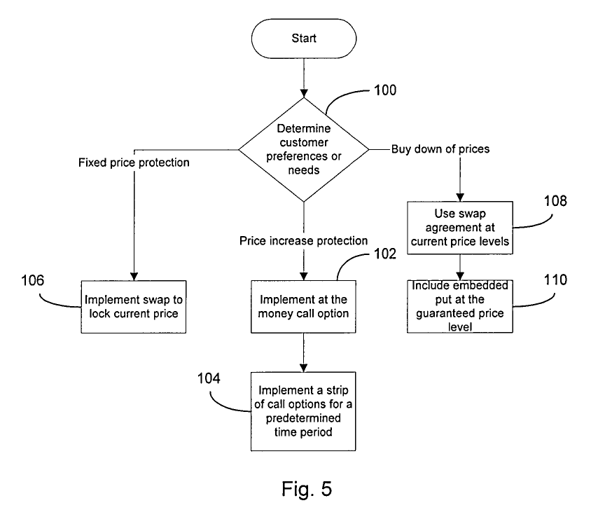

With reference to FIG. 5, a flow chart is provided that illustrates several exemplary price increase protection methodologies. Depending on the preferences or needs of the customer (e.g., the dealer/manufacturer 14 and/or purchaser 16), the plan may allow for fixed fuel prices, a buy down of current fuel prices, or simply protection against future price increases. The correct choice depends on the needs of the marketing program and/or the customer(s).

As indicated at block 100 of FIG. 5, the preferences or needs of the customer are determined. Those needs may suggest that the best approach is fixed price protection, price increase protection, or a buy down of prices. If the customer (e.g., the purchaser 16 and/or dealer/manufacturer 14) prefers complete protection against an increase in fuel prices, but the entire benefit of a decrease in fuel prices, then price increase protection is the preferred method. Price increase protection can be implemented using an “at-the-money” call option, as indicated at clock 102. The call option is placed at the current market price for fuel. For example, if a call option is placed at a price of $3.00 per gallon (the capped price), and fuel prices later increase to $3.50 per gallon, the fuel still may be purchased at $3.00 per gallon via the call option. If prices drop, the purchaser buys fuel at a lower price, without need for the call option.

Preferably, the call and/or put options and/or the swap are based on the client's business needs, and may be set at average fuel prices (e.g., an “at-the-money”) or at some amount offset from current market prices (e.g., an out-of-the-money option). The average fuel price may be determined, for example, by an independent entity that provides daily and/or average fuel prices (e.g., the settlement price of the NAME or prices provided by some other entity such as Gulf Coast Unleaded). Additionally, a strip of options (e.g., a strip of call or put options) may be implemented for a predetermined time period, as indicated at block 104. For example, if the term of the incentive agreement is one year, then a strip of 12 one-month call options can be implemented (sometimes are referred to as a one-year call option with monthly settlements). As will be appreciated, the length of the strip can vary based on the requirements of the parties involved in the agreement. The strip of options allows for regular payment flow, and is preferred to an option dated at the end of the contract range.

If the customer maintains a large fleet of vehicles, fixed price protection may be an attractive option. Under this plan, prices will remain fixed for the duration of the agreement, and the purchaser 16 will pay the agreed upon price for fuel regardless of whether fuel prices increase or decrease. In other words, the protector 12 (e.g., the swap dealer and/or the re-insurer) ensures that the purchaser 16 can buy fuel at a fixed price, regardless of the current price. This enables the purchaser 16, such as a fleet manager, to accurately predict the monthly fuel costs for the entire fleet. Fixed price protection can be implemented via a swap at any price, as indicated at block 106.

A buy down of fuel prices may be attractive for a number of different reasons. For example, a purchaser 16 may have a limited budget for fuel, and a buy down of fuel enables the purchaser 16 to minimize costs associated with fuel. Another example can be drawn to vehicles that have low or marginal fuel economy. The buy down of fuel may make certain types of vehicles more attractive since fuel costs are reduced by the buy down. The buy down can be implemented, for example, using a swap at the market fuel price, and then an embedded put can be implemented at the guaranteed price level, as indicated at blocks 108 and 110. The combination of the swap and embedded put are referred to as a participating swap. Additionally, the dealer/manufacturer 14 contributes additional funds to achieve the buy down level (e.g., to buy down $3.00 per gallon to $2.50 per gallon, the dealer/manufacturer 14 contributes $0.50 per gallon times the number of gallons).

For example, if the average price of fuel at the time of the agreement is $3.00 per gallon and the sponsor (e.g., dealer/manufacturer) offers to buy down the fuel cost to $2.50 per gallon, then a swap is placed at $3.00 per gallon and a put is placed at $2.50 per gallon. If fuel prices increase, then the swap protects the dealer/manufacturer 14 from the price increase. Further, the put protects the dealer/manufacturer 14 from costs associated with significant price drops. For example, if the swap is set at $3.00/gallon, and fuel prices drop to $2.00/gallon, the dealer/manufacturer will owe $1.00 per gallon to the swap dealer, and receive $0.50 per gallon from the put, thereby limiting the dealer/manufacturer's liability to $0.50 per gallon.

The dealer/manufacturer 14 then would contribute an amount to achieve the buy down price. For example, assuming the market price of fuel is at $3.00 per gallon at the end of the month, and the agreement calls for a buy down to $2.50 per gallon, the dealer/manufacturer 14 directly pays $0.50 per gallon times the agreed upon number of gallons to the purchaser 16. If average fuel prices drop of $2.75 per gallon, then the dealer/manufacturer 14 pays $0.25 per gallon ($2.75-$2.50) times the agreed upon number of gallons to the purchaser 16, and $0.25 per gallon ($3.00-$2.75) times the agreed upon number of gallons to the swap dealer. If the average fuel price increases (e.g., to $3.35 per gallon), then the swap dealer pays $0.35 per gallon times the agreed upon number of gallons to the dealer/manufacturer 14, who then forwards this amount to the purchaser 16 along with an additional $0.50 per gallon times the agreed number of gallons to achieve the $2.50 buy down. In each case, the purchaser receives the allotted amount of fuel for no more than $2.50 per gallon.

The above price protection examples may be based only on wholesale fuel costs. According to another embodiment, price protection may be implemented using wholesale fuel costs with a retail component, and is referred to herein as Pump Price Protection. Fuel prices include two price components; the retail price component and the wholesale price component. The retail price component includes transportation costs, taxes and profit, while the wholesale price component includes the costs associated with obtaining and refining crude oil. Hedging on the wholesale price component addresses most of the problems associated with rising or falling fuel costs. Preferably, hedged fuel price protection is implemented based on at least wholesale prices. In other words, the hedge is based on a process that corresponds to delivery of fuel at specified locations, before transportation, taxes and dealer profits.

Pump price protection differs from wholesale price protection discussed herein because unlike wholesale price protection, there is no secondary hedging market for the retail price component. The risks associated with this methodology are mainly transportation price increases, tax increases and profit margin increases. Transportation price increases may be due to ethanol requirements and changes in the transportation network. Tax increases may be due to national gas tax increase to deter consumption and line up better with Europe, or tax increases by large states that may affect the national average.

While the retail price component is not traded and, thus, a price is not set, the retail price component can be calculated using the wholesale price and the market price of fuel. For example, if the market price for fuel is $3.00 per gallon, and the wholesale price for fuel is $2.28 per gallon, then the retail component is $3.00 minus $2.28 or $0.72 per gallon.

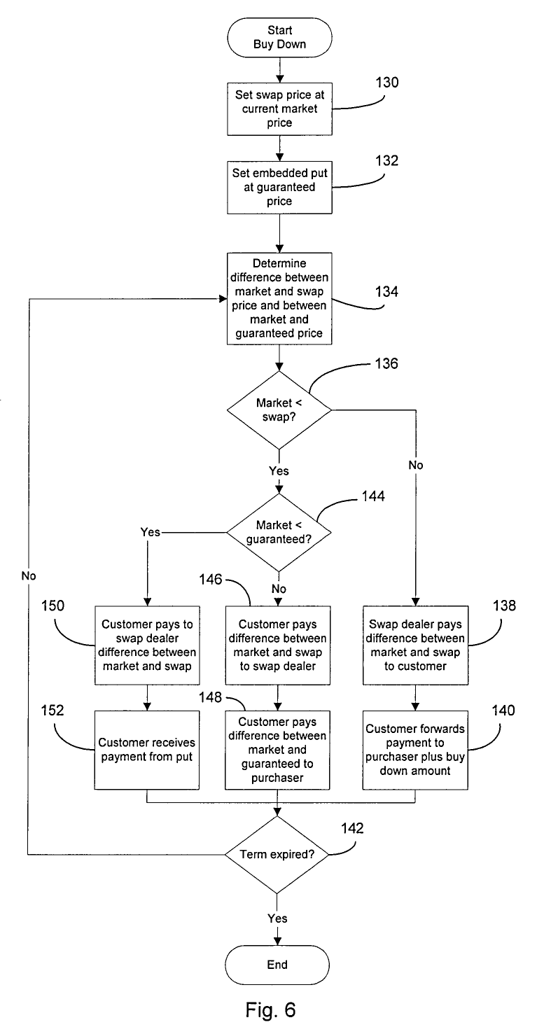

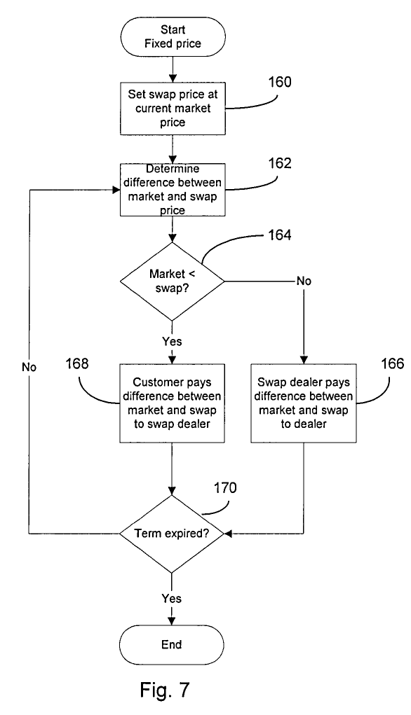

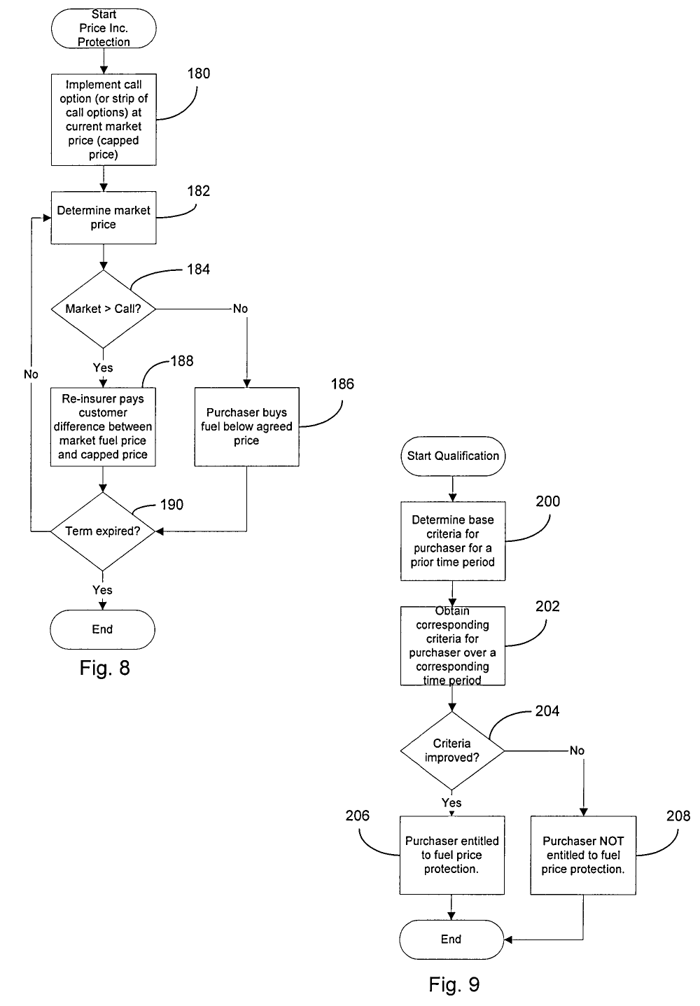

A preferred method of implementing hedged fuel price protection within the cost of an automobile will now be described. FIG. 6 describes the steps for a buy down of fuel prices, FIG. 7 describes the steps for fixed fuel prices, and FIG. 8 describes the steps for price increase protection. As will be appreciated, the methods shown in FIGS. 6-8 may be implemented based on wholesale prices alone, or based on wholesale prices in conjunction with a retail component (i.e., pump price protection).

Referring to FIG. 6, a flow chart is provided that shows exemplary steps for implementing a buy down of fuel prices. Beginning at block 130, a swap price is set for fuel on the retail and/or wholesale level. The swap price for wholesale fuel cost can be easily determined using conventional techniques, as fuel is readily traded on the wholesale market. With respect to the swap price for the retail component of fuel costs, this cost can be calculated from the costs associated with taxes, transportation costs and dealer profits.

At block 132, an embedded put is placed at the guaranteed price level. For example, if the plan calls for a buy down of fuel to $2.50 per gallon (assuming current prices are at $3.00 per gallon), then the embedded put having a specified settlement term (e.g., monthly) is placed at $2.50 per gallon. Next at block 134, the difference between the fuel cost (wholesale and/or retail) and the respective swap price is determined. At block 136, if the market price is greater than or equal to the respective swap price, then at block 138 the swap dealer pays the difference to the dealer/manufacturer 14. Then at block 140, the dealer/manufacturer 14 adds to the swap dealer's payment the amount corresponding to the buy down (in the present example $0.50 per gallon times the number of gallons). This total sum then is forwarded to the purchaser 16, resulting in the purchaser effectively paying $2.50 per gallon. At step 142, it is determined whether the agreement has expired. If it has not expired, then the method moves back to step 134 and repeats. If the agreement has expired, then the method is complete.

Moving back to block 136, if the market fuel price (wholesale and/or retail component) is less than the swap price, then at block 144 the market fuel price is compared to the guaranteed price. If the market fuel price is less than the guaranteed price, then at block 146 the dealer/manufacturer 14 pays the difference between the market price and the swap price to the swap dealer, and at block 148, the dealer/manufacturer 14 pays the difference between the market fuel price and the guaranteed price to the purchaser 16. This again results in the purchaser effectively paying $2.50 per gallon. For example, if the swap is at $3.00 per gallon, the guaranteed price is $2.50 per gallon, and the market price is $2.75 per gallon, the dealer/manufacturer pays $0.25 per gallon times the number of gallons to the purchaser 16, and $0.25 per gallon times the number of gallons to the swap dealer.

Moving back to block 144, if the market fuel price is less than the guaranteed price, then at block 150 the dealer/manufacturer 14 pays the difference between the market fuel price and the swap price to the swap dealer, and at block 152, the dealer/manufacturer 14, via the embedded put, receives payment for the difference between the average fuel price and the guaranteed price. Since the market fuel price is less than the guaranteed price, no payment is made to the purchaser 16. For example, if the swap is at $3.00 per gallon, the guaranteed price is $2.50 per gallon, and the market price is $2.00 per gallon, the dealer/manufacturer pays nothing to the purchaser (the price is below the guaranteed price) and $1.00 per gallon times the number of gallons to the swap dealer. Further, the dealer/manufacturer receives $0.50 per gallon times the number of gallons from the embedded put.

Referring now to FIG. 7, a flow chart is shown that illustrates exemplary steps for executing fixed price protection. Beginning at block 160, a swap price is set at the current market fuel price (wholesale and/or retail). At block 162, the difference between the market price and the swap price is determined. If at block 164, the market price is greater than or equal to the swap price, then at block 166 the swap dealer pays the difference between the market fuel price and the swap price to the dealer/manufacturer 14. Moving back to block 164, if the market fuel price is less than the swap price, then the dealer/manufacturer 14 pays the difference between the market fuel price and the swap price to the swap dealer. At block 170, it is determined whether the term of the agreement has expired. If it has not expired, then the method moves back to block 162 and repeats, otherwise the method is complete. Thus, regardless of actual fuel prices, the purchaser 16 pays the same amount for fuel for the allotted volume of fuel.

Moving now to FIG. 8, a flow chart is provided that illustrates exemplary steps for implementing price increase protection. Beginning at block 180, a call option is implemented at a desired market price (retail and/or wholesale). Preferably, the call option is implemented as a strip of call options over the term of the agreement. For example, for a one-year agreement, a strip of twelve one-month call options can be implemented so as to spread the potential payments over the term of the agreement. Next, at block 182 the market price is determined (e.g., wholesale prices on the NYMEX or the like, calculation of the retail component, etc.).

At block 184, if the market price is less than or equal to the call price, then at block 186 the purchaser 16 buys fuel at or below the protected level, and no payment is made. However, if the average fuel price is greater than the call price, then at block 188 re-insurer pays the difference between the market fuel price and the call price. At block 190, it is determined if the term of the agreement has expired, and if not, the process moves back to block 182 and repeats.

For example, if market price for fuel is $3.00 per gallon and price increase protection is desired, then a call option is placed at $3.00 per gallon. If prices drop below $3.00 per gallon, the compensation is not provided, as fuel prices are lower. If prices rise to $3.50 per gallon, however, then the re-insurer pays to the customer (e.g., the dealer/manufacturer 14 and/or purchaser 16) the amount over $3.00 per gallon (i.e., 0.50 per gallon times the number of gallons).

Referring to FIG. 9, another embodiment of the invention is shown. The embodiment of FIG. 9 implements a qualification process prior to receiving benefits from the fuel protection plan. This qualification process can encourage fuel consumers to use less fuel, or may encourage the purchase of a new vehicle (as opposed to a used vehicle, for example). As will be appreciated, the methodology of FIG. 9 may be utilized with any of the price protection methodologies described herein.

Beginning at block 200, a measurement is made with respect to a specific criteria selected by the promoter (e.g., the dealer/manufacturer 14). In the present example, the desire is to minimize fuel consumption, so the qualification criteria can be a reduction in the amount of fuel consumed by the purchaser 16. As will be appreciated, fuel consumption can be reduced in a number of different ways. For example, the annual distance driven can be reduced and/or the vehicle's fuel efficiency can be increased. Thus, prior to implementing the plan, a baseline number relating to fuel efficiency is obtained for the purchaser 16. This baseline can be obtained, for example, from the purchaser's trade-in vehicle. More specifically, the type of vehicle and/or the mileage on the vehicle can be used to establish a baseline value (e.g., average miles driven per month, MPG rating of vehicle, etc.) and the purchaser will be entitled to fuel price protection only if the baseline value is met or exceeded. As will be appreciated, other baseline figures may be obtained based on different factors.

Next at block 202, the purchaser's actual data is assembled. This data can be assembled, for example, using systems already implemented in modern automobiles. Many vehicles already include on-board computer systems as well as communication means for transmitting information (e.g., built in wireless systems or the like). The computer system can be programmed to record the number of miles traveled over a predetermined time period, and this information can be transmitted via the wireless communication system to a data collection center for dissemination. Alternatively, the purchaser can drive the vehicle into the dealer or any authorized data recording center, and the mileage may be manually recorded. As will be appreciated, any means can be used to collect data relating to the driving habits of the purchaser without departing from the scope of the invention.

Once the data has been assembled, it can be compared to the purchaser's previous driving habits (e.g., compared to data obtained from the previous automobile, from previous recordings at the data center, etc.). If the measured criteria (e.g., mileage) for a specific time period has been met or improved from a corresponding time period by a predetermined threshold level, then at block 206 the purchaser is entitled to fuel price protection. However, if the measured criteria has not been met, then at block 208 the user is not entitled to the fuel price protection.

While the method is described in terms of driving distance, any type of qualifying test may be implemented without departing from the scope of the invention. For example, other factors may be considered in determining eligibility, such as whether the car is a hybrid, the size of the engine relative to the previous engine (including displacement as well as horsepower or the like), actual fuel economy relative advertised fuel economy, the buyer's status (e.g., first time buyer), etc.

The method of FIG. 9 encourages drivers to reduce the number miles driven and/or to improve fuel efficiency. As a result, less fuel is used, thereby creating less pollution and less traffic congestion.

Although specific computer program code is not illustrated or described herein, it will be appreciated that a person who has ordinary skill in the field of computer programming and/or in the field of finance would be able to write a computer program in an appropriate computer program language to carry out the functions described herein.

### INDUSTRIAL APPLICABILITY

The invention may be used to provide fuel price protection.

1. A method of encouraging vehicle sales, comprising
providing a vehicle purchaser an assurance that fuel for a purchased vehicle can be purchased in effect at a prescribed pricing.

2. The method of claim 1, said providing comprises limiting the providing for a prescribed quantity of fuel per unit time.

3. The method of claim 2, said limiting comprises limiting the total time.

4. The method of claim 1, said providing comprising providing the assurance on a per vehicle basis.

5. The method of claim 1, said providing comprising providing the assurance on a per fleet of purchased vehicles basis.

6. The method of claim 1, comprising determining the amount of fuel per unit time for which the providing is given the purchaser, determining the actual price of such amount of fuel, and if the actual price exceeds the prescribed pricing, providing payment to the vehicle purchaser of the difference.

7. A method of providing quantitative value to a consumer in a consumer transaction, comprising
providing fuel price protection for a fuel quantity over a time period, including
providing payment to the consumer or the consumer's designee based on the difference between a first value of an established fuel price and a second value related to the actual price of the fuel quantity if the second value exceeds the first value.

8. The method of claim 7, said providing fuel price protection comprising providing fuel price protection for one or more automotive vehicles as part of a purchase or lease of the one or more vehicles.

9. The method of claim 7, wherein providing fuel price protection is for a fixed quantity of fuel without regard to whether or not the fuel was used by the consumer and wherein the fuel quantity.

10. The method of claim 7, wherein the second value is an average price of the fuel during the time period.

11. A method of providing vehicle fuel-related price protection, comprising
acquiring financial instruments to acquire a fuel product at future times,
based at least in part on the cost to acquire such financial instruments, on the anticipated value of such financial instruments during a first prescribed time frame, and on the anticipated average price of vehicle fuel during a second time frame, determining a commercially valuable price at which to sell fuel price protection for a quantity of fuel to provide payment to a consumer, customer or their designee based on the difference between a first value of an established fuel price and a second value related to the actual price of the fuel quantity if the second value exceeds the first value.

12. The method of claim 11, wherein the actual value is average value.

13. The method of claim 11, wherein such financial instruments are purchase options.

14. The method of claim 11, wherein said determining a commercially valuable price comprises determining supply and demand for vehicle fuel.

15. The method of claim 11, wherein said acquiring financial instruments comprises acquiring options pertaining to at least one or more of gasoline, heating oil and crude oil.

16. The method of claim 11, said determining comprising investigating at least one of the factors of crude oil market supply, crude oil demand or crude oil price; investigating at least one of the factors of gasoline supply, gasoline demand or gasoline price, and determine hedges for compensating for fluctuations in the investigated factors.

17. The method of claim 16, further comprising selling a fuel price guarantee to a customer for the commercially valuable price.

18. The method of claim 11, further comprising selling a fuel price guarantee for the commercially valuable price to a consumer, to a customer or to a designee of a consumer or a customer.

19. The method of claim 18, said selling comprising selling fuel price protection to compensate for wholesale price increases above levels at the time of selling to the consumer, customer or designee.

20. The method of claim 18, said selling comprising selling fuel price rollback of existing prices to roll back the prices of fuel to a more attractive level while providing fuel price increase protection.

21. The method of claim 11, said acquiring comprising acquiring financial instruments comprises acquiring at least one or more of options, futures or combinations.

22. A method of providing price protection for fuel, comprising guaranteeing that the effective cost per unit of fuel over a given time period will not exceed a predetermined price.

23. The method of claim 22, said guaranteeing comprising acquiring financial instruments to protect against rises in the cost per unit of fuel over a given time period that is the same or different from the first mentioned given time period.

24. The method of claim 23, said guaranteeing comprising guaranteeing the effective cost of a predetermined quantity of fuel to a user of fuel and providing to the user a payment based on the predetermined quantity of fuel, the average cost of fuel over such second mentioned time period and the predetermined price if the average cost of fuel over such second mentioned time period exceeds such predetermined price.

25. The method of claim 22, said guaranteeing comprising providing fuel price protection to compensate for wholesale price increases above levels at the time of selling to the consumer, customer or designee.

26. The method of claim 22, said guaranteeing comprising providing fuel price rollback of existing prices to roll back the prices of fuel to a more attractive level while providing fuel price increase protection.

27. The method of claim 22, comprising providing to a recipient of such price protection for a prescribed quantity of fuel a payment based at least in part on the average price of fuel over a prescribed time period, a guaranteed fuel price, and the prescribed quantity of fuel, provided that the average price of fuel over the prescribed time period exceeds the guaranteed fuel price during that prescribed time period without regard to whether the prescribed quantity of fuel was used by the recipient.

28. The method of claim 7, wherein the providing fuel price protection includes basing the fuel price protection on a wholesale price component of the fuel and/or a retail price component of the fuel.

29. The method of claim 28, wherein basing the fuel price protection on the wholesale price component includes basing the wholesale price component on prices set by an independent entity.

30. The method of claim 28, wherein basing the fuel price protection on the retail price component includes basing the retail price component on the fuel wholesale price component and market price for fuel.

31. The method of claim 7, wherein providing fuel price protection includes using at least one of fixed price protection, price increase protection, or buy down of price.

32. The method of claim 31, wherein using buy down of price includes implementing the buy down of price via a swap agreement and a put option.

33. The method of claim 31, wherein using price increase protection includes implementing a call option.

34. The method of claim 33, wherein using the call option includes using a strip of call options.

35. The method of claim 31, wherein using fixed price protection includes implementing a swap.

36. The method of claim 7, wherein providing payment includes determining if the consumer meets at least one predetermined criteria and denying payment if the criteria is not satisfied.

37. The method of claim 36, wherein the predetermined criteria is at least one of distance traveled over a predetermined time period, fuel efficiency over a predetermined time period, a characteristic of the vehicle, or a characteristic of the engine.

38. The method of claim 7, wherein providing fuel price protection includes at least one of an automobile dealer, automobile manufacturer, leasing consultant, or leasing agent directly or indirectly providing the fuel price protection.

39. A method of purchasing or leasing one or more vehicles, comprising acquiring with the vehicle price protection for at least a limited quantity of fuel, wherein price protection includes an assurance from a vehicle seller, lessor, or some other entity that at a predetermined time in the future the quantity of fuel will be available to an owner or lessee of the vehicle at or below an agreed upon price.
